(19) United States
(12) Patent Application Publication
(10) Pub. No.: US 2026/0075533 A1
(43) Pub. Date: Mar. 12, 2026

(54) METHOD FOR BALANCING PERFORMANCE, FUNCTIONALITY, AND POWER CONSUMPTION OF SIGNAL BOOSTER, AND SIGNAL BOOSTER SYSTEM

(71) Applicant: SHENZHEN HUAPTEC CO., LTD, SHENZHEN (CN)

(72) Inventors: YANWEI WANG, SHENZHEN (CN); SONGLIN ZHOU, SHENZHEN (CN); YANLIN XIE, SHENZHEN (CN)

(21) Appl. No.: 18/920,016

(22) Filed: Oct. 18, 2024

(30) Foreign Application Priority Data
Sep. 11, 2024 (CN) 202411274038.8

(51) Int. Cl. H04W 52/06

(52) U.S. Cl. CPC H04W 52/06

(57) ABSTRACT

A method for balancing performance, functionality, and power consumption of a signal booster, and a signal booster system are provided. The method includes steps of obtaining state information of a radio frequency (RF) link by a detector and sending the state information of the RF link by the detector to a processor, receiving the state information of the RF link by the processor and comparing the state information of the RF link with preset thresholds by the processor to obtain comparison results, formulating adjustment instructions according to the comparison results by the processor, and sending the adjustment instructions by the processor to a control end, and executing the adjustment instructions by the control end, controlling an electrical parameter of the RF link by the control end, and adjusting power consumption of the RF link by the control end.

### TECHNICAL FIELD

The present disclosure relates to a technical field of signal processing, and in particular to a method for balancing performance, functionality, and power consumption of a signal booster, and a signal booster system.

### BACKGROUND

Currently, end consumers opt to use mobile phone signal boosters, such as repeaters, full-bar boosters, and mobile phone signal amplifiers, to amplify mobile phone signals in a case that the mobile phone signals are weak, such mobile phone signal boosters are typically installed in various settings for amplifying the mobile phone signals, such as homes, offices, vehicles, malls, subways, mountainous areas, or any place where the mobile phone signals are weak or there is even no mobile phone signal at all. In general, such mobile phone signal boosters consist of duplexers, analog or digital filters, amplifiers, detectors, controllers, RF (radio frequency) cables, and antennas, a basic principle of which is to receive signals from a base station (BS) through a BS-end antenna, enter the signals into a downlink for amplification, retransmit the signals after the amplification through a mobile station (MS)-end antenna to cover areas with weak signals, receive mobile phone signals of the areas with the weak signals through the MS-end antenna, enter the mobile phone signals of the areas with the weak signals into an uplink for the amplification and other processing, and retransmit the mobile phone signals after the amplification and the other processing back to the BS.

However, in many settings, users do not fully utilize entire performance and functionality of the mobile phone signal boosters, for example, the mobile phone boosters typically do not operate at maximum transmission power; or the mobile phone signal boosters do not amplify signals at the same time across all frequency bands; or during peak traffic periods of the BS, stronger signals are transmitted, thereby causing the mobile phone signal boosters to operate at higher transmission power, and during off-peak periods of the BS, such as in the second half of the night, transmission power of the mobile phone signal boosters is reduced or even the signals are temporarily shut down on certain frequency bands, then downlink transmission power of the mobile phone boosters is also decreased or there is even no signal at all. Moreover, with the increasing of sales of related products of the mobile phone signal boosters, such as multi-band signal boosters, in practical applications of the multi-band signal boosters, since frequency bands covered by BSs in each region are different and mobile phones of the users typically do not use services from all local operators at the same time, it is uncommon for all frequency bands to have signals or require signals at the same time. Furthermore, in settings including the vehicles, boats, etc., signals around the mobile phone signal boosters change along with movement of environment, sometimes becoming very weak in certain frequency bands and even falling below a signal-to-noise ratio (SNR) threshold, thereby rendering them unusable. Furthermore, in a case that devices, such as the mobile phones, customer premises equipment (CPE), routers, etc., transmit signals, corresponding transmission power is not always at a corresponding maximum level, which is related to a principle of communication networks; when the devices, such as the mobile phones, are in an environment with the weak signals, corresponding transmission power needs to be stronger to establish communication with the BS or corresponding receiving equipment, additionally, the devices, such as the mobile phones, are not continuously transmitting signals but are idle and not transmitting for most of the time.

Therefore, when there are cases where the signals around the mobile phone signal boosters are very weak or even fall below the SNR threshold, the signals are shut off, the signals transmitted by the devices, such as the mobile phones, are weak, and no signal is transmitted, corresponding mobile phone signal boosters may experience weak reception or no uplink or downlink reception, and output signals of the corresponding mobile phone signal boosters are further weakened or disappear.

For simplifying circuit design and ensuring that related products meet regulatory and standard requirements at all times and in all scenarios, common mobile phone signal boosters and similar wireless transceiver systems generally have fixed and unchangeable power consumption and performance after leaving factories. However, the related products are affected to always operate at a high power consumption. Especially as the number of frequency bands in the related products increases, power consumption of the related products also rises, leading to increased energy consumption, higher heat generation, greater requirements for cooling structures, and reduced reliability and durability. Moreover, since the related products of the mobile phone signal boosters and the similar wireless transceiver systems keep to operate multiple frequency bands at the same time, noise floor interference and other potential interference, such as inter-band crosstalk, may be increased.

### SUMMARY

Aiming at problems in the prior art, the present disclosure provides a method for balancing performance, functionality, and power consumption of a signal booster and a signal booster system, which analyzes detected signal status and determines a lower-power consumption strategy that meets performance requirements, and adjusts power consumption the signal booster accordingly.

Based on above, the present disclosure provide technical solutions as follows.

The method for balancing the performance, the functionality, and the power consumption of the signal booster is provided, comprising following steps.

S1: obtaining state information of a radio frequency (RF) link by a detector and sending the state information of the RF link by the detector to a processor.

S2: receiving the state information of the RF link by the processor and comparing the state information of the RF link with preset thresholds by the processor to obtain comparison results, formulating adjustment instructions according to the comparison results by the processor, and sending the adjustment instructions by the processor to a control end, where the control end comprises a power management system and a bypass system.

S3: executing the adjustment instructions by the control end, controlling an electrical parameter of the RF link by the control end, and adjusting power consumption of the RF link by the control end.

The detector has a detection function, the detector detects corresponding state information of any node of the RF link, the detector is a combination of circuits with the detection function or devices with the detection function. The RF link comprises a downlink and/or an uplink, the RF link is configured to perform noise reduction, amplification enhancement, attenuation, and frequency modulation on signals. The state information of the RF link comprises signal strength, output power, temperature information of the signal booster, and gain information of the signal booster, the preset thresholds correspond to the state information, the preset thresholds comprise a signal strength threshold, an output power threshold, a temperature threshold, and a gain threshold.

Furthermore, the comparison results comprise determining a signal strength level as low, extremely low, or non-existent, determining corresponding output power of the uplink or the downlink as normal, high, low, and extremely low, determining working temperature of the signal booster as high or low, and determining gains of the RF link as high, medium gain, and low.

Furthermore, first adjustment instructions of the adjustment instructions sent by the processor to the power management system for the reducing power consumption of the RF link comprise reducing voltages of active devices in the RF link by the power management system, shutting down the uplink and the downlink by the power management system, and partially shutting down the RF link and reducing corresponding voltages of corresponding active devices in rest of the RF link. The voltages comprise power supply voltages or bias voltages, and by reducing the voltages of the active devices in the RF link, current or the power consumption of the RF link is reduced.

Furthermore, if the processor determines the signal strength level of the RF link as low, the power management system reduces the voltages of the active devices in the RF link; if the processor determines the signal strength level of the RF link as extremely low or non-existent, the power management system shuts down the uplink and the downlink; if the processor determines the corresponding output power of the uplink as normal and determines the corresponding output power of the downlink as low, or if the processor determines the corresponding output power of the downlink as normal and determines the corresponding output power of the uplink as low, the power management system reduces corresponding voltages of corresponding active devices in the RF link with the low output power; if the processor determines the corresponding output power of the uplink as normal and determines the corresponding output power of the downlink as extremely low, or if the processor determines the corresponding output power of the downlink as normal and determines the corresponding output power of the uplink as extremely low, the power management system shuts off a last stage device of the active devices in the RF link with extremely low output power and reduces voltages of rest of the active devices in the RF link with the extremely low output power, or the power management system shuts off all the active devices of the RF link with the extremely low output power; if the processor determines the corresponding output power of the uplink as high and determines the corresponding output power of the downlink as low, or if the processor determines the corresponding output power of the downlink as high and determines the corresponding output power of the uplink as low, the power management system reduces voltages of a first part of the active devices in the RF link with low output power and maintains voltages of a second part of the active devices in the RF link with the low output power; and if the processor determines the working temperature of the signal booster as high, the processor measures frequency band information in the RF link to provide important levels of a frequency band circuit and executes different adjustment instructions for reducing power consumption according to the important levels. The processor presets compensation parameters for a corresponding part of the RF link with reduced voltages, the compensation parameters comprise gain compensation values, power compensation values, and frequency compensation values. The processor sends the compensation parameters to the RF link while sending corresponding adjustment instructions to reduce corresponding voltages.

Furthermore, second adjustment instructions of the adjustment instructions sent by the processor to the bypass system for reducing noise floor comprise bypassing some of the active devices in the RF link, bypassing the uplink, bypassing the downlink and bypassing the signal booster. A bypass function is controlled by a switch on a bypass path, closing the switch on the bypass path activates the bypass function, while opening the switch deactivates the bypass function, and the processor sends corresponding adjustment instructions to the switch for opening the switch or closing the switch.

Furthermore, if the processor determines the gain of the RF link as high, bypassing the signal booster; if the processor determines a corresponding gain of the uplink or the downlink as medium, a corresponding part of the RF link with a medium gain is bypassed; and if the processor determines the corresponding gain of the uplink or the downlink as low, corresponding active devices in a corresponding part of the RF link with a low gain are bypassed. The power management system executes corresponding adjustment instructions comprising reducing corresponding voltages or cutting off power supply to the corresponding actives being bypassed or corresponding parts of the RF link being bypassed.

Furthermore, the state information obtained by the detector and the adjustment instructions formulated by the processor are informed to a user, and the user manually controls power consumption of the RF link. The user directly sends a user instruction to the processor, a power management chip, and the RF link, when the processor simultaneously receives the state formation from the detector and the user instruction from the user, the user instruction has priority over the state formation, the processor prioritizes processing the user instruction, a processing manner of the power management chip is the same as a processing manner of the processor.

The present further provides the signal booster system based on the method for balancing the performance, the functionality of the signal booster. The signal booster system comprises a multi-band signal booster system. The multi-band signal booster system consists of a plurality of single-band signal booster systems, the plurality of the single-band signal booster systems are disposed in parallel, and each of the plurality of the single-band signal booster systems comprises the detector, the processor, the control end, and the RF link. The detector is configured to obtain the state information of the RL link and send the state information of the RL link to the processor, the detector is the combination of the circuits with the detection function or the devices with the detection function. The processor is configured to receive the state information of the RF link and compare the state information of the RF link with the preset thresholds to obtain comparison results, formulate adjustment instructions according to the comparison results, and send the adjustment instructions to the control end, the processor is a microcontroller with storage, algorithms, and control functions, or a circuit with equivalent functionality. The control end is configured to execute the adjustment instruction, control the electrical parameter of the RF link, and adjust the power consumption of the RF link.

Furthermore, the RF link is configured to amplify wireless signal, the RF link comprises the downlink and the uplink, and devices for processing the wireless signals are disposed in the RF link.

Furthermore, the control end comprises the power management system and the bypass system, the power management system is a device or a circuit capable of regulating voltage, current, power supply switches, or chip enable signals. The bypass system is configured to bypass some of the devices in the RF link, bypassing the uplink, bypassing the downlink, and bypassing the signal booster.

The present disclosure provides the method for balancing the performance, the functionality of the signal booster. By comparing the state information obtained of the RF link obtained by the detector with the preset thresholds, the signal strength, the output power, the temperature information of the signal booster, and the gain information of the signal booster are determined. Based on the comparison results, different adjustment instructions are formulated to reduce the voltages of the active components in the RF link, shut down the uplink and the downlink, partially shut down the RF link, and reduce the corresponding voltages of the corresponding active devices in the rest of the RF link, or, bypassing bypass some of the devices in the RF link, bypassing the uplink, bypassing the downlink, and bypassing the signal booster. Based aforementioned adjustments, the signal booster operates at a lower power consumption state most of the time, thereby reducing heat generation, decreasing a size and cost of cooling structures, reducing noise floor interference, and increasing reliability and durability. On the other hand, when the signal booster is at a low temperature, the adjustment instructions sent by the processor involve increasing the voltages of the active devices in the RF link, setting increased voltage parameters, intervals, and maximum voltages, allowing greater current to flow through the active devices, generating heat, and restoring normal operation, thereby improving the adaptability to environmental temperatures of the signal booster.

### BRIEF DESCRIPTION OF DRAWINGS

FIG. 1 illustrates a first block diagram of detecting state of a radio frequency (RF) link and adjusting power consumption of the RF link.

FIG. 2 illustrates a second block diagram of detecting the state of the RF link and adjusting the power consumption of the RF link.

FIG. 3 illustrates a block diagram of a single-band signal booster for detecting the state of the RF link and adjusting the power consumption of the RF link.

FIG. 4 illustrates a block diagram of a signal booster with a bypass circuit within the RF link.

FIG. 5 illustrates a block diagram of the signal booster with the RF link being entirely bypassed.

FIG. 6 illustrates a block diagram of the signal booster being entirely bypassed.

FIG. 7 illustrates a block diagram of a dual-band signal booster for detecting the state of the RF link and adjusting the power consumption of the RF link.

### DETAILED DESCRIPTION OF EMBODIMENTS

Reference is made in detail to exemplary embodiments below, examples of which are illustrated in accompanying drawings. The following description refers to the accompanying drawings in which the same numbers in different drawings represent the same or similar elements unless otherwise represented. The implementations described in following exemplary embodiments do not represent all implementations consistent with the present disclosure.

### First Embodiment

Technical problems addressed by the embodiment is that current signal boosters and other wireless transceiver systems similar to the current signal boosters have an increasing number of frequency bands, which leads to higher power consumption, increased power depletion, and intensified heat generation, additionally, multi-band operation increases noise floor interference. Aiming at the technical problems, power consumption and heating of the current signal boosters and the other wireless transceiver systems similar to the current signal boosters need to be improved.

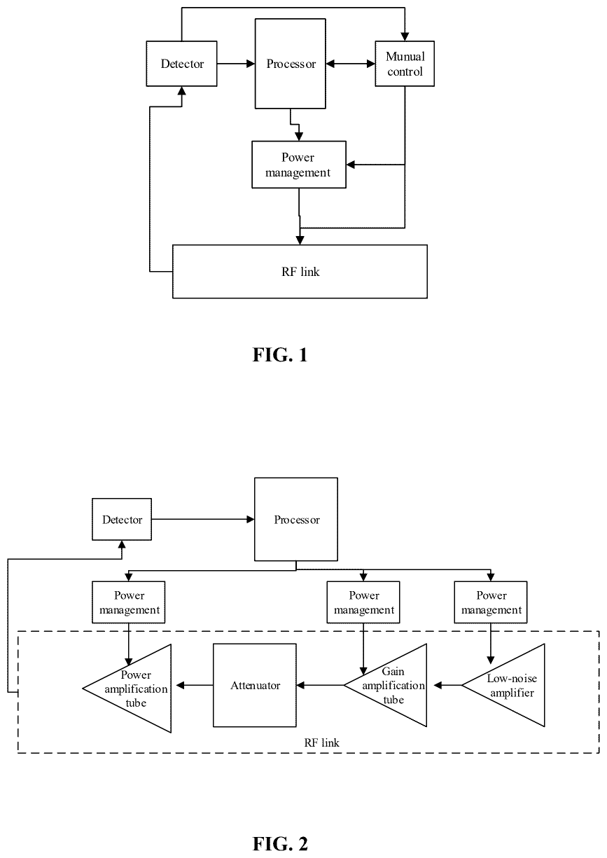

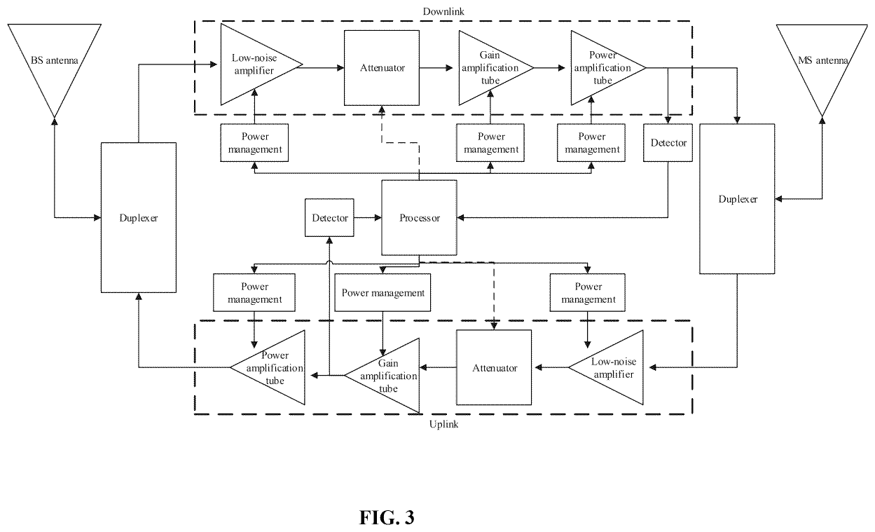

As shown in FIGS. 1-6, a method for balancing performance, functionality, and power consumption of a signal booster is provided, comprising following steps.

S1: obtaining state information of a radio frequency (RF) link by a detector and sending the state information of the RF link by the detector to a processor.

S2: receiving the state information of the RF link by the processor and comparing the state information of the RF link with preset thresholds by the processor to obtain comparison results, formulating adjustment instructions according to the comparison results by the processor, and sending the adjustment instructions by the processor to a control end, where the control end comprises a power management system and a bypass system.

S3: executing the adjustment instructions by the control end, controlling an electrical parameter of the RF link by the control end, and adjusting power consumption of the RF link by the control end.

The detector has a detection function, the detector detects corresponding state information of any node of the RF link, the detector is a combination of circuits with the detection function or devices with the detection function.

The RF link comprises a downlink and/or an uplink, the downlink is configured to amplify and process a first wireless signal received from a base station (BS) antenna and transmit the wireless signal to an mobile station (MS) antenna, the first wireless signal processed by the downlink is a downlink output signal, the uplink is configured to amplify and process a second wireless signal received from the MS antenna and transmit the second wireless signal to the BS antenna, the second wireless signal processed by the uplink is an uplink output signal. The first wireless signal and the second wireless signal are subjected to noise reduction, amplification enhancement, attenuation, and frequency modulation processing by active devices and passive devices respectively in the downlink and the uplink, and active devices require different power supply voltages or power supply currents, and the frequency modulation generally refers to processing, such as changing a frequency or changing a frequency band range.

The state information of the RF link comprises signal strength, output power, temperature information of the signal booster, and gain information of the signal booster. The processor formulates the adjustment instructions in combination with the received state information on the premise of satisfying performance and function required by the RF link. The processor has storage, calculation and control functions, and the processor compares the state information with the preset thresholds.

The preset thresholds correspond to the state information, the preset thresholds comprise a signal strength threshold, an output power threshold, a temperature threshold, and a gain threshold.

The signal strength threshold comprises a first signal threshold and a second signal threshold, the first signal threshold is higher than the second signal threshold, a signal strength level of the uplink output signal or a downlink output signal is determined according to comparison between signal strength of the uplink output signal or downlink output signal and the signal strength threshold; if the signal strength is between the first signal threshold and the second signal threshold, the signal strength level is determined to be low; if the signal strength is lower than the second signal threshold, the signal strength level is determined to be extremely low or non-existent.

The output power threshold comprises a first power threshold, a second power threshold, and a third power threshold, the first power threshold is higher than the second power threshold, and the third power threshold is higher than the first power threshold. Based on comparison between output power of the uplink output signal or the downlink output signal and the output power threshold, levels of the output power of the uplink output signal or the downlink output signal are determined.

If the output power of the uplink output signal or the downlink output signal falls between the first power threshold and the third power threshold, the output power is determined as normal.

If the output power of the uplink output signal or the downlink output signal exceeds the third power threshold, the output power is determined as high.

If the output power of the uplink output signal or the downlink output signal falls between the first power threshold and the second power threshold, the output power is determined as low.

If the output power of the uplink output signal or the downlink output signal is lower than the second power threshold, the output power is determined as extremely low.

The temperature threshold comprises a high temperature threshold and a low temperature threshold. If temperature information falls between the high temperature threshold and low temperature threshold, the processor does not respond. If the temperature information exceeds the high temperature threshold, working temperature of the signal booster is determined as high; if the temperatures information is lower than the working temperature of the signal booster is determined as low, and when the working temperature is lowered the low temperature threshold, the signal booster is in a static power consumption state without performing any tasks. At this point, although the devices in the RF link are powered on and generate heat, the devices in the RF link still cannot properly function. For example, under low temperatures, capacitance of electrolytic capacitors decreases, and frequency-type devices, such as oscillators, phase-locked loops, crystal oscillators, clock circuits, and chips, as well as filters, may experience frequency drift leading to abnormal operation or inability to correctly function. Additionally, performance characteristics of amplification components, such as low-noise amplifiers, gain amplification tubes, and power amplification tubes may change or become less reliable.

The gain threshold is set at three levels from high to low, namely high gain threshold, medium gain threshold, and low gain threshold. Gain information greater than the high gain threshold is determined to be high gain. Gain information between the high gain threshold and the medium gain threshold is determined to be medium gain. Gain information between the medium gain threshold and the low gain threshold is determined to be low gain. Gain information lower than the high gain threshold is determined to be normal gain, where normal gain corresponds to actual application requirements. When the gain information is greater than the low gain threshold, noise floor increases along with higher interference. The higher the level of the gain information, the more it exceeds the actual application requirements. The gain threshold is set according to actual needs known to those who skilled in the field.

The processor formulates different adjustment instructions to the power management system and the bypass system according to the state information of the RL link, first adjustment instructions of the adjustment instructions sent by the processor to the power management system for the reducing power consumption of the RF link comprise reducing voltages of active devices in the RF link by the power management system, shutting down the uplink and the downlink by the power management system, and partially shutting down the RF link and reducing corresponding voltages of corresponding active devices in rest of the RF link. Specifically, the reducing the voltages of the active devices in the RF link by the power management system comprises reducing corresponding voltages of a part of the active devices in the RF link by the power management system and reducing corresponding voltages of all the active devices in the RF link by the power management system. The voltages comprise power supply voltages or bias voltages, and by reducing the voltages of the active devices in the RF link, current or the power consumption of the RF link is reduced. Voltage regulation methods include, but are not limited to, stepped adjustment, incremental adjustment, analog adjustment, and other approaches. By reducing the voltages of active devices in the RF link, shutting down the uplink and downlink, partially shutting down the RF link, and reducing the corresponding voltages of the corresponding active devices in the rest of the RF link, the signal booster is capable of operating at lower power consumption, thereby reducing heat generation.

If the processor determines the signal strength level of the RF link as low, the power management system reduces the voltages of the active devices in the RF link. Specifically, if the processor determines the signal strength level of the downlink output signal as low, a sent adjustment instruction is to reduce corresponding voltages of corresponding active devices in the downlink; if the processor determines the signal strength level of the uplink output signal as low, the sent adjustment instruction is to reduce corresponding voltages of corresponding active devices in the uplink. The active devices comprise, but are not limited to, low-noise amplifiers (LNAs), gain amplification tubes, power amplification tubes, and filters.

If the processor determines the signal strength level of the RF link as extremely low or non-existent, the power management system shuts down the uplink and the downlink. Specifically, when the processor determines the signal strength level of the downlink output signal as extremely low or non-existent, the processor sends a corresponding adjustment instruction to shut off power supply to the uplink and downlink to meet requirements for downlink balance.

If the processor determines the corresponding output power of the uplink as normal and determines the corresponding output power of the downlink as low, or if the processor determines the corresponding output power of the downlink as normal and determines the corresponding output power of the uplink as low, the power management system reduces corresponding voltages of corresponding active devices in the RF link with the low output power. Specifically, if the corresponding output power of the downlink is normal, the corresponding output power of the uplink is low, the corresponding voltages of the corresponding active devices in the uplink is reduced; if the corresponding output power of the uplink is normal, the corresponding output power of the downlink is low, the corresponding voltages of the corresponding active devices in the downlink is reduced.

If the processor determines the corresponding output power of the uplink as normal and determines the corresponding output power of the downlink as extremely low, or if the processor determines the corresponding output power of the downlink as normal and determines the corresponding output power of the uplink as extremely low, the power management system shuts off a last stage device of the active devices in the RF link with extremely low output power and reduces voltages of rest of the active devices in the RF link with the extremely low output power, or the power management system shuts off all the active devices of the RF link with the extremely low output power. Specifically, if the corresponding output power of the downlink is normal, but the corresponding output power of the uplink is extremely low, the power management system shuts off a corresponding last stage device of the corresponding active devices in the uplink (typically a power amplifier tube), while keeping corresponding preceding stages of the corresponding active devices in the uplink operational, in this way, the corresponding voltages of the corresponding active devices in the uplink are reduced, typically reducing voltages of amplifier tubes in the RF link, or all the corresponding actives devices in the uplink are shut off; if the corresponding output power of the uplink is normal, but the corresponding output power of the downlink is extremely low, the power management system shuts off a corresponding last stage device of the corresponding active devices in the downlink, while keeping corresponding preceding stages of the corresponding active devices in the downlink operational, in this way, the corresponding voltages of the corresponding active devices in the downlink are reduced, or all the corresponding actives devices in the downlink are shut off. Shutting off the last stage device satisfies requirements for silence and reduces noise. Keeping rest devices in the RF link operational ensures that when a signal is present, the signal may be detected, which then triggers an alarm to wake up other devices for exiting a silent mode, and amplifying the signal.

If the processor determines the corresponding output power of the uplink as high and determines the corresponding output power of the downlink as low, or if the processor determines the corresponding output power of the downlink as high and determines the corresponding output power of the uplink as low, the power management system reduces voltages of a first part of the active devices in the RF link with low output power and maintains voltages of a second part of the active devices in the RF link with the low output power. In this way, better linearity and other performance metrics are maintained to combat interference. The first part of the active devices includes circuits or devices that generate less interference, such as filters. The second part of the active devices includes those with interference-resistance properties, such as LNAs. This approach helps to mitigate the interference caused by a corresponding part of the RF link with high output power on a corresponding part of the RF link with the low output power.

If the processor determines the working temperature of the signal booster as high, the processor measures frequency band information in the RF link to provide important levels of a frequency band circuit and executes different adjustment instructions for reducing power consumption according to the important levels.

When the processor determines the working temperature of the signal booster as low, the processor sends a corresponding adjustment instruction to increase the voltages of the active components in the RF link. The corresponding adjustment instruction sent by the processor involves increasing the voltages of the active devices in the RF link, setting increased voltage parameters, intervals, and maximum voltages, allowing greater current to flow through the active devices, generating heat, and restoring normal operation.

The processor presets compensation parameters for a corresponding part of the RF link with reduced voltages, the compensation parameters comprise gain compensation values, power compensation values, and frequency compensation values. For example, an attenuator presets attenuation for compensation adjustments. The processor sends the compensation parameters to the RF link while sending corresponding adjustment instructions to reduce corresponding voltages to avoid an impact of voltage reduction on the RF link, thereby meeting regulatory or standard requirements.

Second adjustment instructions of the adjustment instructions sent by the processor to the bypass system for reducing noise floor comprise bypassing some of the active devices in the RF link, bypassing the uplink, bypassing the downlink and bypassing the signal booster. A bypass function is controlled by a switch on a bypass path, closing the switch on the bypass path activates the bypass function, while opening the switch deactivates the bypass function, and the processor sends corresponding adjustment instructions to the switch for opening the switch or closing the switch. Specifically, the bypassing some of the active devices in the RF link comprises bypassing individual devices or simultaneously bypassing multiple devices.

If the processor determines the gain of the RF link as high, bypassing the signal booster; if the processor determines a corresponding gain of the uplink or the downlink as medium, a corresponding part of the RF link with a medium gain is bypassed; and if the processor determines the corresponding gain of the uplink or the downlink as low, corresponding active devices in a corresponding part of the RF link with a low gain are bypassed. The power management system executes corresponding adjustment instructions including reducing corresponding voltages or cutting off power supply to the corresponding actives being bypassed or corresponding parts of the RF link being bypassed. The corresponding active devices in the corresponding part of the RF link with the low gain are part of amplification section, and by bypassing the corresponding active devices in the corresponding part of the RF link with the low gain or the RF link, the noise floor interference is reduced, and by bypassing the devices, or reducing the voltages of the active devices of the RF link, or shutting down power supply, energy consumption reduction is further achieved.

The state information obtained by the detector and the adjustment instructions formulated by the processor are informed to a user, and the user manually controls power consumption of the RF link. The user directly sends a user instruction to the processor, a power management chip, and the RF link, when the processor simultaneously receives the state formation from the detector and the user instruction from the user, the user instruction has priority over the state formation, the processor prioritizes processing the user instruction, a processing manner of the power management chip is the same as a processing manner of the processor.

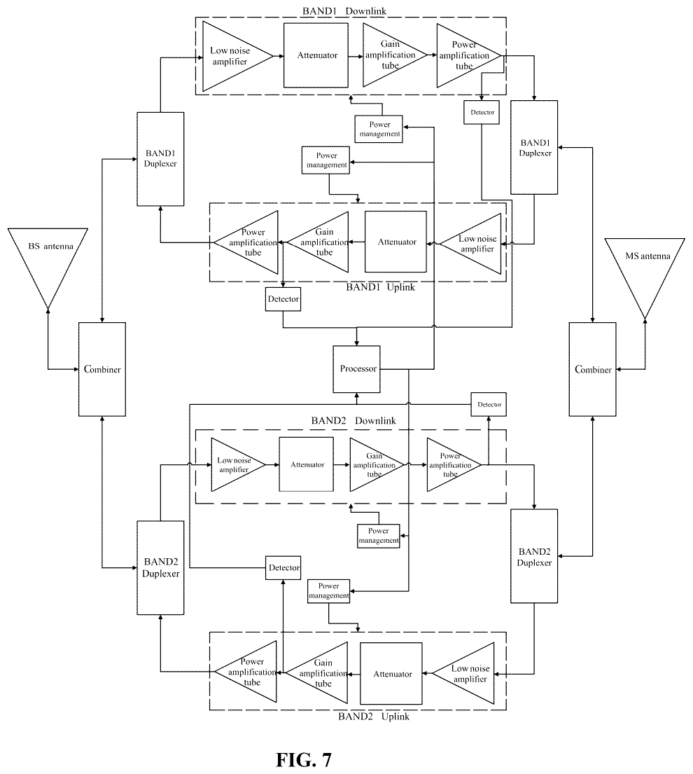

The method described above applies to single-band signal booster. As shown in FIG. 7, for a dual-band signal booster or a multi-band signal booster, it is common that not all bands have signals. When it is detected that certain bands have low signals or no signals, the processor reduces power consumption of these bands or shuts down these bands. The methods for power consumption reduction are the same as those for the single-band signal booster.

Power consumption reduction operations described above are all carried out under a condition of meeting required performance and functionality of the RF link.

### Second Embodiment

As shown in FIGS. 1-3 and 7, a signal booster system is further provided, comprising a multi-band signal booster system. The multi-band signal booster system consists of a plurality of single-band signal booster systems, the plurality of the single-band signal booster systems are disposed in parallel, and each of the plurality of the single-band signal booster systems comprises the detector, the processor, the control end, and the RF link.

The detector is configured to obtain the state information of the RL link and send the state information of the RL link to the processor, the detector is the combination of the circuits with the detection function or the devices with the detection function.

The processor is configured to receive the state information of the RF link and compare the state information of the RF link with the preset thresholds to obtain comparison results, formulate adjustment instructions according to the comparison results, and send the adjustment instructions to the control end, the processor is a microcontroller with storage, algorithms, and control functions, or a circuit with equivalent functionality. For example, the processor is an STM32 processor or is selected from other types of processors or circuits with similar functionalities, such as field-programmable gate arrays (FPGAs), central processing units (CPUs).

The control end is configured to execute the adjustment instruction, control the electrical parameter of the RF link, and adjust the power consumption of the RF link.

The RF link is configured to amplify wireless signal, the RF link comprises the downlink and the uplink, and devices for processing the wireless signals are disposed in the RF link. For example, the devices for processing the wireless signals are disposed along a signal transmission path and sequentially comprise an LNA, an attenuator, a gain amplification tube, and a power amplifier tube. The devices consist of active devices and passive devices, with the active devices requiring different supply voltages and circuits. Both ends of the RF link are connected to duplexers, a first one of the duplexers is connected to the BS antenna, and a second one of the duplexers is connected to the MS antenna, which enables signal transmission between the BS antenna, the RF link, and the MS antenna.

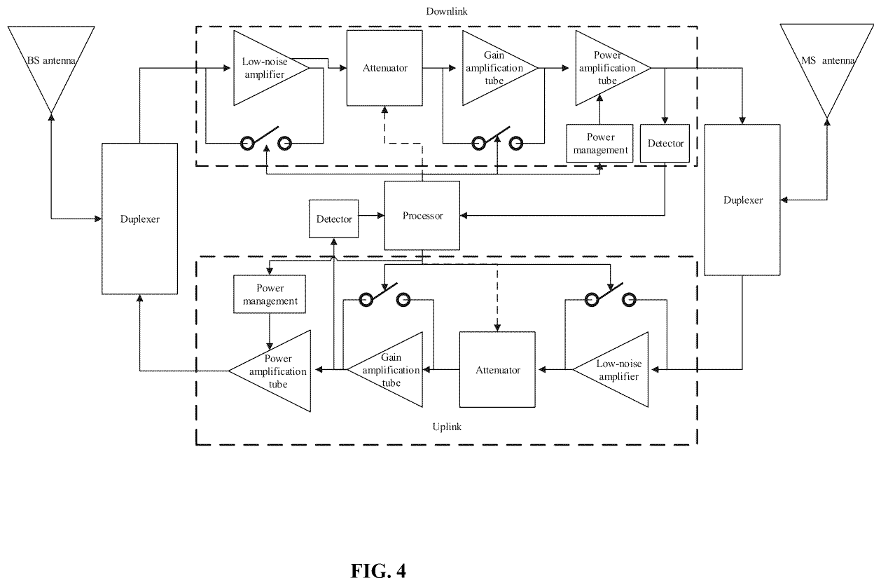

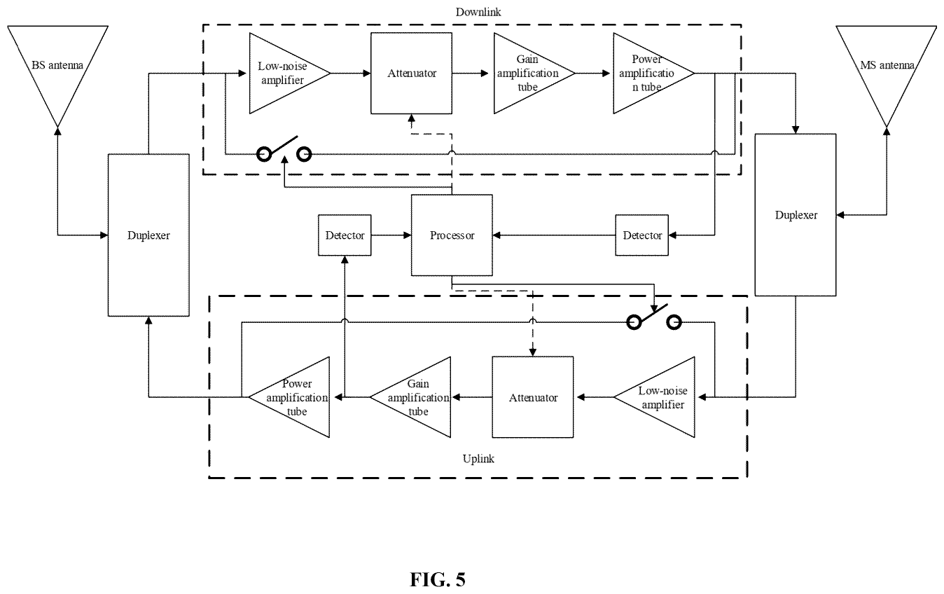

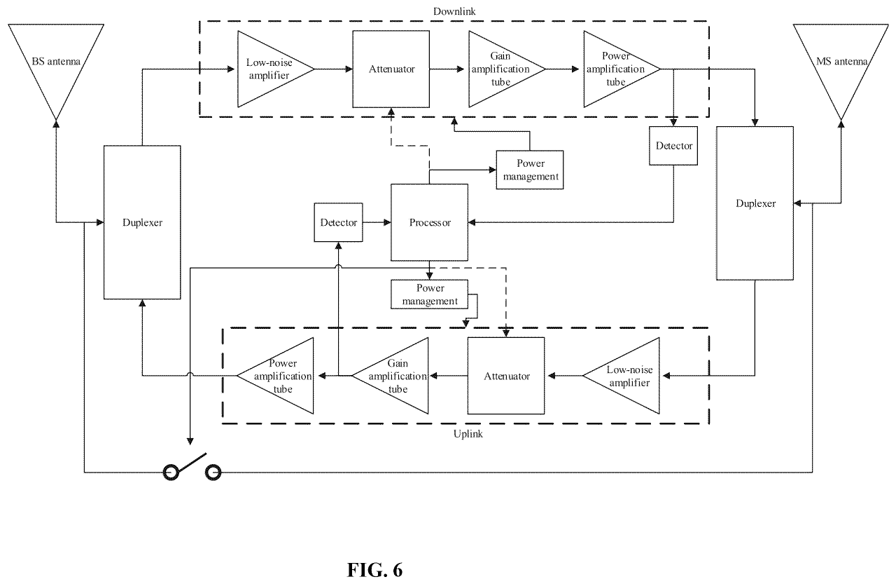

The control end comprises the power management system and the bypass system, the power management system is a device or a circuit capable of regulating voltage, current, power supply switches, or chip enable signals. The bypass system is configured to bypass some of the devices in the RF link, bypassing the uplink, bypassing the downlink, and bypassing the signal booster. As shown in FIG. 4, bypassing some of the devices in the RF link involves bypassing active components in the RF link and proving a control switch. Bypass connection points are arranged at both ends of a corresponding part of the devices being bypassed, for example, the LNA or the gain amplification tube are bypassed. As shown in FIG. 5, bypassing the uplink means bypassing an entire uplink, corresponding bypass connection points are arranged at both ends of the entire uplink and the control switch is provided. A principle of bypassing the downlink is the same as bypassing the uplink. As shown in FIG. 6, bypassing the signal booster involves arranging the bypass connection points at both ends of the duplexers and providing the control switch.

In the multi-band signal booster system, first ends of the plurality of the single-band signal booster systems converge and connect to a first combiner, second ends of the plurality of the single-band signal booster systems also converge and connect to a second combiner. The first combiner is connected to the BS antenna, and the second combiner is connected to the MS antenna, which enables signal transmission between the BS antenna, the plurality of the single-band signal booster systems, and the MS antenna.

Finally, it should be noted that the above embodiments are only used to illustrate the technical solutions of the present disclosure and are not limited thereto. Although the present disclosure is described in detail with reference to the foregoing embodiments, those who skilled in the art should understand that the technical solutions described in the foregoing embodiments may still be modified, or some or all of technical features may be equivalently replaced; and these modifications or replacements do not make essence of corresponding technical solutions separate from the technical solutions of the embodiments of the present disclosure.

What is claimed is:

1. A method for balancing performance, functionality, and power consumption of a signal booster, comprising:
S1: obtaining state information of a radio frequency (RF) link by a detector and sending the state information of the RF link by the detector to a processor;
S2: receiving the state information of the RF link by the processor and comparing the state information of the RF link with preset thresholds by the processor to obtain comparison results, formulating adjustment instructions according to the comparison results by the processor, and sending the adjustment instructions by the processor to a control end, wherein the control end comprises a power management system and a bypass system;
S3: executing the adjustment instructions by the control end, controlling an electrical parameter of the RF link by the control end, and adjusting power consumption of the RF link by the control end;
wherein the detector has a detection function, the detector detects corresponding state information of any node of the RF link, the detector is a combination of circuits with the detection function or devices with the detection function;
the RF link comprises a downlink and/or an uplink, the RF link is configured to perform noise reduction, amplification enhancement, attenuation, and frequency modulation on signals; and
the state information of the RF link comprises signal strength, output power, temperature information of the signal booster, and gain information of the signal booster, the preset thresholds correspond to the state information, the preset thresholds comprise a signal strength threshold, an output power threshold, a temperature threshold, and a gain threshold.

2. The method for balancing the performance, the functionality, and the power consumption of the signal booster according to claim 1, wherein the comparison results comprise determining a signal strength level as low, extremely low, or non-existent, determining corresponding output power of the uplink or the downlink as normal, high, low, and extremely low, determining working temperature of the signal booster as high or low, and determining gains of the RF link as high, medium gain, and low.

3. The method for balancing the performance, the functionality, and the power consumption of the signal booster according to claim 2, wherein first adjustment instructions of the adjustment instructions sent by the processor to the power management system for the reducing power consumption of the RF link comprise reducing voltages of active devices in the RF link by the power management system, shutting down the uplink and the downlink by the power management system, and partially shutting down the RF link and reducing corresponding voltages of corresponding active devices in rest of the RF link;
wherein the voltages comprise power supply voltages or bias voltages, and by reducing the voltages of the active devices in the RF link, current or the power consumption of the RF link is reduced.

4. The method for balancing the performance, the functionality, and the power consumption of the signal booster according to claim 3, wherein if the processor determines the signal strength level of the RF link as low, the power management system reduces the voltages of the active devices in the RF link;
if the processor determines the signal strength level of the RF link as extremely low or non-existent, the power management system shuts down the uplink and the downlink;
if the processor determines the corresponding output power of the uplink as normal and determines the corresponding output power of the downlink as low, or if the processor determines the corresponding output power of the downlink as normal and determines the corresponding output power of the uplink as low, the power management system reduces corresponding voltages of corresponding active devices in the RF link with the low output power;
if the processor determines the corresponding output power of the uplink as normal and determines the corresponding output power of the downlink as extremely low, or if the processor determines the corresponding output power of the downlink as normal and determines the corresponding output power of the uplink as extremely low, the power management system shuts off a last stage device of the active devices in the RF link with extremely low output power and reduces voltages of rest of the active devices in the RF link with the extremely low output power, or the power management system shuts off all the active devices of the RF link with the extremely low output power;
if the processor determines the corresponding output power of the uplink as high and determines the corresponding output power of the downlink as low, or if the processor determines the corresponding output power of the downlink as high and determines the corresponding output power of the uplink as low, the power management system reduces voltages of a first part of the active devices in the RF link with low output power and maintains voltages of a second part of the active devices in the RF link with the low output power;
if the processor determines the working temperature of the signal booster as high, the processor measures frequency band information in the RF link to provide important levels of a frequency band circuit and executes different adjustment instructions for reducing power consumption according to the important levels;
the processor presets compensation parameters for a corresponding part of the RF link with reduced voltages, the compensation parameters comprise gain compensation values, power compensation values, and frequency compensation values; and
the processor sends the compensation parameters to the RF link while sending corresponding adjustment instructions to reduce corresponding voltages.

5. The method for balancing the performance, the functionality, and the power consumption of the signal booster according to claim 2, wherein second adjustment instructions of the adjustment instructions sent by the processor to the bypass system for reducing noise floor comprise bypassing some of the active devices in the RF link, bypassing the uplink, bypassing the downlink and bypassing the signal booster; and
a bypass function is controlled by a switch on a bypass path, closing the switch on the bypass path activates the bypass function, while opening the switch deactivates the bypass function, and the processor sends corresponding adjustment instructions to the switch for opening the switch or closing the switch.

6. The method for balancing the performance, the functionality, and the power consumption of the signal booster according to claim 5, wherein if the processor determines the gain of the RF link as high, bypassing the signal booster;
if the processor determines a corresponding gain of the uplink or the downlink as medium, a corresponding part of the RF link with a medium gain is bypassed;
if the processor determines the corresponding gain of the uplink or the downlink as low, corresponding active devices in a corresponding part of the RF link with a low gain are bypassed; and
the power management system executes corresponding adjustment instructions comprising reducing corresponding voltages or cutting off power supply to the corresponding actives being bypassed or corresponding parts of the RF link being bypassed.

7. The method for balancing the performance, the functionality, and the power consumption of the signal booster according to claim 1, wherein the state information obtained by the detector and the adjustment instructions formulated by the processor are informed to a user, and the user manually controls power consumption of the RF link;
the user directly sends a user instruction to the processor, a power management chip, and the RF link, when the processor simultaneously receives the state formation from the detector and the user instruction from the user, the user instruction has priority over the state formation, the processor prioritizes processing the user instruction, a processing manner of the power management chip is the same as a processing manner of the processor.

8. A signal booster system, based on the method for balancing the performance, the functionality of the signal booster according to claim 1, comprising:
a multi-band signal booster system;
wherein the multi-band signal booster system consists of a plurality of single-band signal booster systems, the plurality of the single-band signal booster systems are disposed in parallel, and each of the plurality of the single-band signal booster systems comprises the detector, the processor, the control end, and the RF link;
the detector is configured to obtain the state information of the RL link and send the state information of the RL link to the processor, the detector is the combination of the circuits with the detection function or the devices with the detection function;
the processor is configured to receive the state information of the RF link and compare the state information of the RF link with the preset thresholds to obtain comparison results, formulate adjustment instructions according to the comparison results, and send the adjustment instructions to the control end, the processor is a microcontroller with storage, algorithms, and control functions, or a circuit with equivalent functionality; and
the control end is configured to execute the adjustment instruction, control the electrical parameter of the RF link, and adjust the power consumption of the RF link.

9. The signal booster system according to claim 8, wherein the RF link is configured to amplify wireless signal, the RF link comprises the downlink and the uplink, and devices for processing the wireless signals are disposed in the RF link.

10. The signal booster system according to claim 9, wherein the control end comprises the power management system and the bypass system, the power management system is a device or a circuit capable of regulating voltage, current, power supply switches, or chip enable signals, and the bypass system is configured to bypass some of the devices in the RF link, bypassing the uplink, bypassing the downlink, and bypassing the signal booster.
